(19) United States
(12) Patent Application Publication
(10) Pub. No.: US 2011/0034207 A1
(43) Pub. Date: Feb. 10, 2011

(54) Mobile Station Device and Transmission Power Control Method

(75) Inventor: Toru Sahara, Kanagawa (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/937,703

(22) PCT Filed: Mar. 11, 2009
(86) PCT No.: PCT/JP2009/054690

§ 371 Date: Oct. 13, 2010

(30) Foreign Application Priority Data
Apr. 18, 2008 (JP) 2008-108739

(51) Int. Cl. H04B 7/00

(52) U.S. Cl. 455/522

(57) ABSTRACT

A mobile station (12) includes a transmission loss calculator (32) for calculating the transmission loss of a broadcast signal sent from a base station and a transmission power controller (34) for controlling the transmission power of an uplink signal to the base station, based on a known base station desired receive power and the transmission loss calculated by the transmission loss calculator (32).

### TECHNICAL FIELD

The present invention relates to a mobile station device and a transmission power control method and, in particular, to a technique for achieving high speed handover.

### BACKGROUND ART

A next generation PHS (eXtended Global Platform) is a mobile communication system which realizes high speed communication using a TDMA/TDD (Time Division Multiple Access/Time Division Duplex) system and an OFDMA (Orthogonal Frequency Division Multiple Access) system. A radio communication interface of the next generation PHS is disclosed in the non-patent document 1 mentioned below.

FIG. 4 is a diagram showing a outgoing call sequence of the next generation PHS. As shown in the diagram, a base station regularly sends a broadcast control channel (BCCH) including the base station ID of its own station, transmission power control information (a negative value indicating the difference between an actual transmission power and the base station maximum transmission power), and so forth (S100). Meanwhile, a mobile station establishes frame synchronization in the downlink direction (the direction from the base station to the mobile station), based on the broadcast control channel (S102), and then sends a timing correct channel (TCCH) corresponding to an uplink synchronous burst signal to the base station (S104).

Having received the timing correct channel from the mobile station, the base station calculates the difference between the receive timing and a desired receive timing of the timing correct channel to use as a timing correct amount (S106). Then, one communication channel for ANCH (Anchor Channel) to be allocated to the mobile station is determined (S108). Note that, in the next generation PHS, each communication channel is composed of a combination of a time slot according to the TDMA (e.g., a time slot length 625 μs) and a subchannel according to the OFDMA, and referred to as a PRU (Physical Resource Unit).

The base station calculates a correction amount of the transmission power of the mobile station, using the difference between the received power of the timing correct channel and a desired receive power (S110), and sends to the mobile station a signaling control channel (downlink SCCH) containing the timing correct amount calculated at S106, the PRU for ANCH, determined at S108, and the correct amount of the transmission power of the mobile station, calculated at S110 (S112).

Having received the signaling control channel from the base station, the mobile station obtains the PRU for ANCH from the received signaling control channel (S114). Then, the mobile station corrects the transmission power of the ANCH, based on the transmission power correct amount contained in the signaling control channel (S116), and also corrects the transmission timing, based on the timing correct amount contained in the signaling control channel, whereby frame synchronization in the uplink direction (the direction from the mobile station to the base station) is established (S118). Further, the mobile station sends an uplink signal to the base station, using the PRU for ANCH obtained at S114, with the transmission power corrected at S116 at the transmission timing corrected at S118 to request allocation of PRUs for EXCH (Extra Channel) (S120).

Having received the uplink ANCH from the mobile station, the base station determines PRUs for EXCH composed of one or more PRUs (S122), and sends a downlink signal containing the determined PRUs for EXCH to the mobile station, using the ANCH (S124).

Note that, in the next generation PHS employing the OFDMA system, receive timing difference and received power difference among uplink signals sent from respective mobile stations cannot be individually corrected in the base station. Therefore, the transmission timing of an uplink signal is corrected in a mobile station, as described above, to prevent inter-symbol interference (ISI). Moreover, an appropriate transmission power is set for a mobile station to prevent interference with an adjacent cell. Non-Patent Document 1: “ARIB STD-T95 ‘OFDMA/TDMA TDD Broadband Wireless Access System (Next Generation PHS)ARIB STANDARD’, Ver. 1.0”, Dec. 12, 2007, Association of Radio Industries and Business

### DISCLOSURE OF THE INVENTION

### Problems to be Solved by the Invention

As described above, as a timing correct channel (TCCH) is a signal to be transmitted before establishment of frame synchronization in the uplink direction, the transmission timing of the timing correct channel is not necessarily synchronized with the receive timing of the same in the base station. This may cause inter-symbol interference (ISI) with an adjacent channel due to the timing correct channel not being received within a guard interval (GI) length.

Such inter-symbol interference is more remarkable when the transmission power of the timing correct channel is higher. Here, the timing correct channel, being a signal to be transmitted before correction of the transmission power of a mobile station, is often transmitted with an unnecessarily high transmission power (e.g., the maximum transmission power). Therefore, influence of inter-symbol interference by the timing correct channel on an adjacent channel is not very small.

The present invention has been conceived in view of the above, and an object thereof is to provide a mobile station device and a transmission power control method capable of appropriately controlling the transmission power of an uplink signal to be sent in response to a broadcast signal from a base station device.

### Means for Solving the Problems

In order to achieve the above described object, a mobile station device according to the present invention is a mobile station device for communicating with a base station device, the mobile station device including transmission loss calculation means for calculating the transmission loss of a broadcast signal sent from the base station device, and transmission power control means for controlling the transmission power of an uplink signal to the base station device, based on a known base station desired receive power and the transmission loss calculated by the transmission loss calculation means.

According to the present invention, it is possible to appropriately control the transmission power of an uplink signal to be sent in response to a broadcast signal from the base station device.

In one aspect of the present invention, the transmission loss calculation means may measure the received power of the broadcast signal, and calculates the transmission loss of the broadcast signal, based on the transmission power of the broadcast signal and the measured received power of the broadcast signal.

In one aspect of the present invention, the transmission loss calculation means may obtain the transmission power of the broadcast signal, based on a known base station maximum transmission power and transmission power control information of the broadcast signal notified by the base station device.

In one aspect of the present invention, the base station device may communicate with the mobile station device, using an orthogonal frequency division multiple access system.

A transmission power control method according to the present invention includes a step of calculating the transmission loss of a broadcast signal sent from a base station device, and a step of controlling the transmission power of an uplink signal to the base station device, based on a known base station desired receive power and the transmission loss of the broadcast signal.

### BRIEF DESCRIPTION OF THE DRAWINGS

FIG. 1 is an entire configuration diagram of a mobile communication system according to an embodiment of the present invention;

FIG. 2 is a functional block diagram of a mobile station according to the embodiment of the present invention;

FIG. 3 is a diagram describing a method for calculating a TCCH transmission power; and

FIG. 4 is a diagram showing a outgoing call sequence of a next generation PHS.

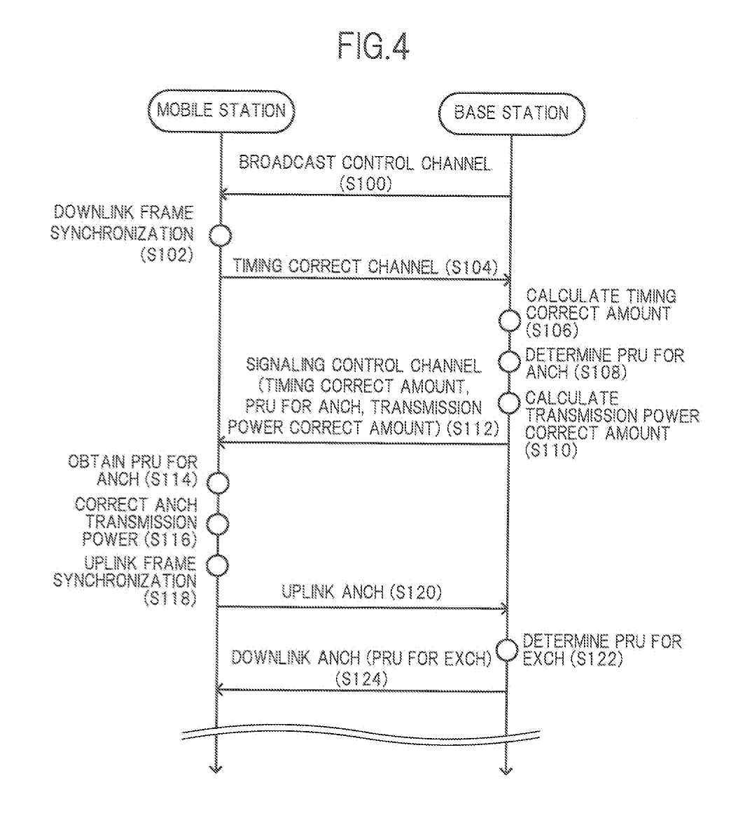

### BEST MODE FOR CARRYING OUT THE INVENTION

In the following, one embodiment of the present invention will be described in detail based on the drawings.

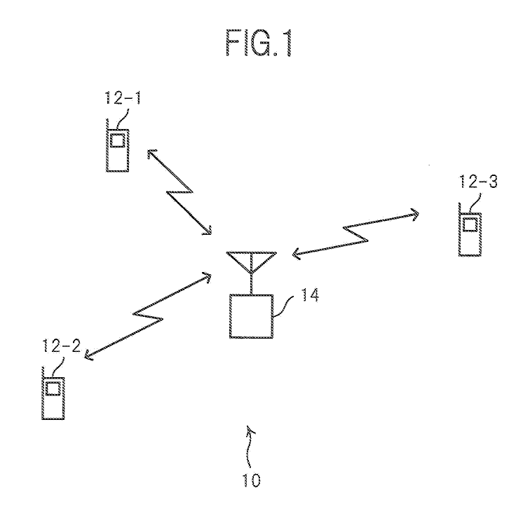

FIG. 1 is an entire configuration diagram of a mobile communication system 10 according to one embodiment of the present invention. As shown in the diagram, the mobile communication system 10 includes a plurality of mobile stations 12 (only the mobile stations 12-1 to 12-3 are shown here) and a base station 14 (only one is shown here).

The base station 14 employs a TDMA/TDD system and an OFDMA system, and communicates with the mobile station 12, using at least one communication channel composed of any time slot according to the TDMA and any subchannel according to the OFDMA.

The mobile station 12 appropriately controls the transmission power of a timing correct channel (TCCH), based on a broadcast control channel (BCCH) sent from the base station 14. In the following, a structure provided to the mobile station 12 to achieve such processing will be described.

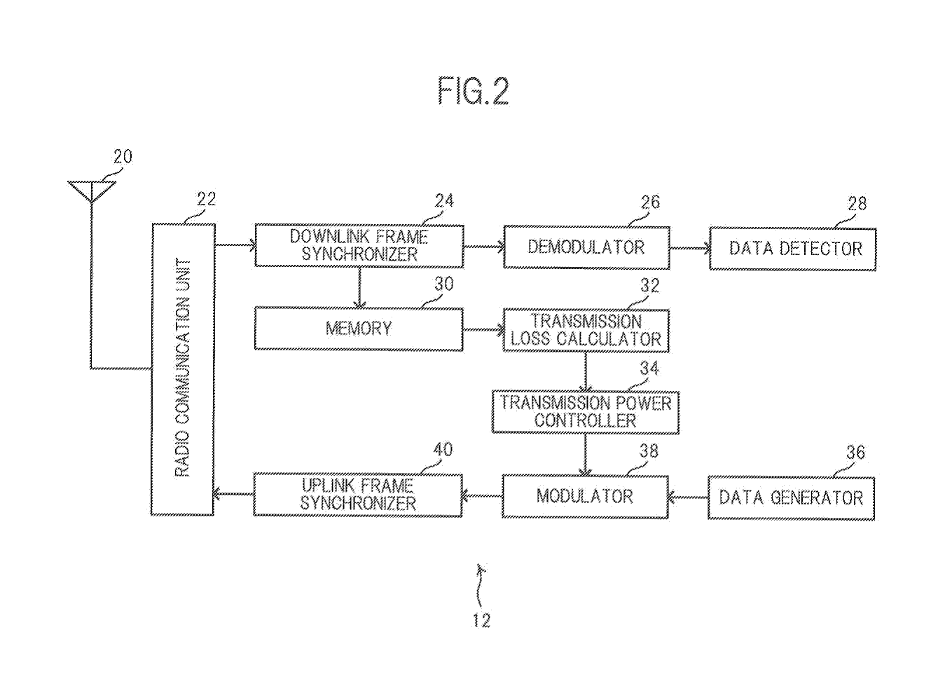

FIG. 2 is a functional block diagram of the mobile station 12. As shown in the diagram, the mobile station 12 includes an antenna 20, a radio communication unit 22, a downlink frame synchronizer 24, a demodulator 26, a data detector 28, a memory 30, a transmission loss calculator 32, a transmission power controller 34, a data generator 36, a modulator 38, and an uplink frame synchronizer 40, with some of these elements built from, e.g., a CPU (Central Processing Unit) or a DSP (Digital Signal Processor).

The antenna 20 receives a radio signal, and outputs the received radio signal to the radio communication unit 22. Also, the antenna 20 sends a radio signal supplied from the radio communication unit 22 to the base station 14. Reception and transmission of a radio signal is switched in response to an instruction from the radio communication unit 22 in a time division manner.

The radio communication unit 22 includes a low noise amplifier, a power amplifier, a local oscillator, a mixer, and a filter. The radio communication unit 22 amplifies a radio signal input from the antenna 20 in the low noise amplifier, and down-converts the amplified radio signal into an intermediate frequency signal before outputting to the downlink frame synchronizer 24. Also, the radio communication unit 22 up-converts a modulated signal input from the uplink frame synchronizer 40 into a radio signal, and amplifies the resultant signal in the power amplifier up to a transmission power level before supplying to the antenna 20.

The downlink frame synchronizer 24 performs frame synchronization with respect to a broadcast control channel (BCCH) sent from the base station 14. That is, the downlink frame synchronizer 24 determines correlation between a signal input from the radio communication unit 22 and a known signal related to the broadcast control channel, and establishes frame synchronization in the downlink direction with the base station 14 based on a time at which correlation of a value equal to or larger than a predetermined value is determined. Moreover, the downlink frame synchronizer 24 measures the received power of a broadcast control channel sent from the base station 14.

The demodulator 26 includes an A/D converter, a serial/parallel converter, an FFT (Fast Fourier Transform) calculator, and a parallel/serial converter, and performs guard interval removal, A/D conversion, serial/parallel conversion, discrete Fourier transform, parallel/serial conversion, and so forth with respect to a signal input from the downlink frame synchronizer 24 to obtain a successive complex symbol string, which are then output to the data detector 28.

The data detector 28 detects a data bit string (received data) among the complex symbol string input from the demodulator 26, the data bit string being in accordance with the modulation scheme of the symbol, and outputs the detected received data to a higher layer (not shown).

The memory 30 includes, e.g., semiconductor memory elements, and stores the received power of a broadcast control channel and so forth, measured by the downlink frame synchronizer 24.

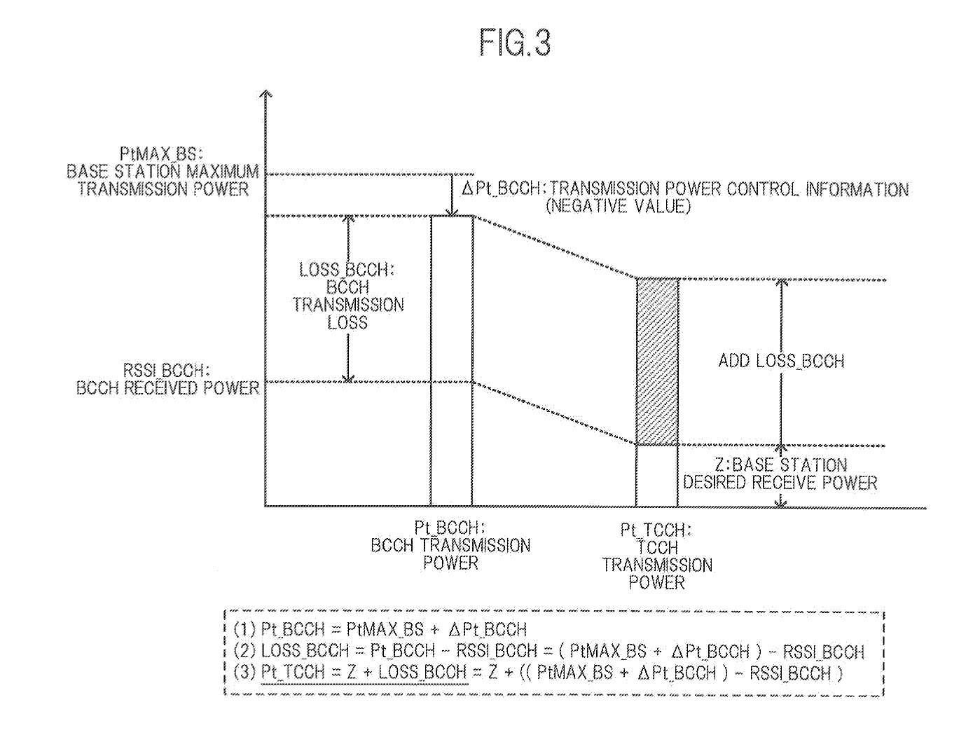

The transmission loss calculator 32 calculates the transmission loss of a broadcast control channel (BCCH) sent from the base station 14. In the following, a method for calculating the transmission loss of a broadcast control channel will be described referring to FIG. 3. As shown in the diagram, the transmission loss LOSS_BCCH of the broadcast control channel corresponds to the difference between the transmission power Pt_BCCH of the broadcast control channel and the received power RSSI_BCCH of the same in the mobile station 12, the transmission loss LOSS_BCCH can be expressed as LOSS_BCCH=Pt_BCCH−RSSI_BCCH. Here, assuming that the known base station maximum transmission power is denoted as PtMAX_BS, and transmission power control information (a negative value contained in the broadcast control channel) of the broadcast control channel is denoted as ΔPt_BCCH, the transmission power Pt_BCCH of the broadcast control channel is expressed as Pt_BCCH=PtMAX_BS+ΔPt_BCCH. Therefore, the transmission loss LOSS_BCCH of the broadcast control channel sent from the base station 14 is calculated as LOSS_BCCH=(PtMAX_BS+ΔPt_BCCH)−RSSI_BCCH. The thus calculated transmission loss LOSS_BCCH can be regarded as the transmission loss between the mobile station 12 and the base station 14.

As described above, the transmission loss calculator 32 calculates the transmission loss LOSS_BCCH of a broadcast control channel, based on the known base station maximum transmission power PtMAX_BS, the transmission power control information ΔPt_BCCH contained in the broadcast control channel, and the received power RSSI_BCCH of the broadcast control channel, stored in the memory 30.

The transmission power controller 34 controls the transmission power of a timing correct channel such that the received power of the timing correct channel (TCCH) in the base station 14 becomes equal to the base station desired receive power Z. Also, the transmission power controller 34 controls the transmission power of an uplink signal subsequent to an ANCH, based on the transmission power correct amount contained in a downlink signal (downlink SCCH or the like) from the base station 14.

In the following, a method for calculating the transmission power of a timing correct channel will be described referring to FIG. 3. As shown in the diagram, in order to obtain the received power of a timing correct channel in the base station 14, the received power being equal to the known base station desired receive power Z, a power obtained by adding the transmission loss LOSS_BCCH between the mobile station 12 and the base station 14 to the base station desired receive power Z may be determined as the transmission power Pt_TCCH of the timing correct channel. That is, the transmission power Pt_TCCH may be determined as Pt_TCCH=Z+LOSS_BCCH.

As described above, the transmission power controller 34 calculates the transmission power Pt_TCCH of a timing correct channel, based on the known base station desired receive power Z and the transmission loss LOSS_BCCH calculated by the transmission loss calculator 32. The calculated transmission power Pt_TCCH is supplied to the modulator 38.

The data generator 36 adds header information and the like in accordance with the format of the transmission channel to a data bit string input from a higher layer (not shown) to thereby generate transmission data. The generated transmission data is output to the modulator 38.

The modulator 38 includes a serial/parallel converter, an IFFT (Inverse Fast Fourier Transform) calculator, a parallel/serial converter, and a D/A converter. The modulator 38 carries out symbol mapping (amplitude and phase allocation) in accordance with the modulation scheme with respect to transmission data input from the data generator 36 to thereby obtain a complex symbol string.

Further, the modulator 38 divides the thus obtained complex symbol string into subcarrier components, and adjusts subcarrier components corresponding to the PRU allocated by the base station 14 such that the transmission power of an uplink signal (TCCH or the like) becomes equal to the transmission power calculated by the transmission power controller 34. Then, the modulator 38 carries out serial/parallel conversion, inverse discrete Fourier transform, parallel/serial conversion, D/A conversion, and so forth, with respect to the respective adjusted carrier components of the complex symbol string, to thereby obtain a baseband OFDM signal. The thus obtained baseband OFDM signal is given a guard interval before being output to the uplink frame synchronizer 40.

The uplink frame synchronizer 40 controls the transmission power of an uplink signal subsequent to an ANCH, based on the timing correct amount contained in a downlink signal (downlink SCCH or the like) from the base station 14.

According to the above described mobile communication system 10, it is possible to appropriately control the transmission power of a timing correct channel (TCCH) to be sent from the mobile station 12 in response to a broadcast control channel (BCCH) from the base station 14. This can reduce inter-symbol interference.

Note that the present invention is not limited to the above described embodiment.

That is, application of the present invention is not limited to the next negation PHS employing the TDMA/TDD system and the OFDMA system, but the present invention has a wide application generally to a mobile communication system.

1. A mobile station device for communicating with a base station device, comprising:
transmission loss calculation means for calculating a transmission loss of a broadcast signal sent from the base station device; and
transmission power control means for controlling a transmission power of an uplink signal to the base station device, based on a known base station desired receive power and the transmission loss calculated by the transmission loss calculation means.

2. The mobile station device according to claim 1, wherein the transmission loss calculation means measures a received power of the broadcast signal, and calculates the transmission loss of the broadcast signal, based on a transmission power of the broadcast signal and the measured received power of the broadcast signal.

3. The mobile station device according to claim 1, wherein the transmission loss calculation means obtains the transmission power of the broadcast signal, based on a known base station maximum transmission power and transmission power control information of the broadcast signal notified by the base station device.

4. The mobile station device according to claim 1, wherein the base station device communicates with the mobile station device, using an orthogonal frequency division multiple access system.

5. A transmission power control method, comprising:
a step of calculating a transmission loss of a broadcast signal sent from a base station device; and
a step of controlling a transmission power of an uplink signal to the base station device, based on a known base station desired receive power and the transmission loss of the broadcast signal.
